(19) United States
(12) Patent Application Publication
(10) Pub. No.: US 2011/0003124 A1
(43) Pub. Date: Jan. 6, 2011

(54) RESIN FOAM

(75) Inventors: Itsuhiro HATANAKA, Osaka (JP); Makoto SAITOU, Osaka (JP); Shigeki ISHIGURO, Osaka (JP); Kazumichi KATO, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Osaka (JP)

(21) Appl. No.: 12/829,806

(22) Filed: Jul. 2, 2010

(30) Foreign Application Priority Data
Jul. 6, 2009 (JP) 2009-160242

(51) Int. Cl. B32B 3/10

(52) U.S. Cl. 428/202; 428/195.1

(57) ABSTRACT

The present invention relates to a resin foam including a foam layer and a surface layer, in which the foam layer has a same composition as the surface layer, and the surface layer has a surface coating ratio defined by the following formula (1) of 40% or more:

$$Surface Coating Ratio ( \% ) = \frac{[ ( Area of surface ) - ( Area of pores existing in surface ) ]}{( Area of surface )} \times 100 \qquad ( 1 )$$

### FIELD OF THE INVENTION

The present invention relates to a resin foam, a foamed member laminate, and an electric/electronic device using the resin foam.

### BACKGROUND OF THE INVENTION

In general, a resin foam is punched out in a required shape so as to correspond to the shape of a member to be used, or processing for pressure-sensitive adhesiveness is applied on the surface of the resin foam in order to facilitate fixing thereof to the above member. However, since the resin foam to which such processing is applied is difficult to handle, a carrier tape is used in some cases in order to efficiency convey the member to a predetermined site. Namely, a resin foam is subjected to various kinds of processing such as punching and processing for pressure-sensitive adhesiveness and, after processing, it is conveyed in a state where it is attached to a carrier tape. On the other hand, after processing, the resin foam is necessarily peeled from the carrier tape, but the resin foam is sometimes broken at peeling when the strength of the surface of the resin foam is low (weak). Particularly, in the case of a resin foam having a high expansion ratio [e.g., a thermoplastic resin foam formed through a step of impregnating a thermoplastic resin with a high-pressure inert gas (e.g., carbon dioxide in a supercritical state or the like) and subsequently reducing the pressure], the breakage at peeling was remarkable since the thickness of the cell wall is thin.

Incidentally, it is known to provide a resin layer on the surface of a resin foam for enhancing the adhesiveness and the sealing ability of the resin foam. For example, for the purpose of enhancing the sealing ability (reinforcement of the foamed layer and conveyance with a carrier tape are not taken into consideration), there has been proposed a foam having, as provided on either of the upper and lower surfaces of a rubber foam having both of closed cells and interconnected cells, a soft coating film softer than the rubber foam (see Patent Document 1). Moreover, there has been proposed a foam excellent in toughness, scratch resistance, abrasion resistance and the like, which is produced by forming a layer of an urethane-based thermoplastic polymer composition on the surface of a polyolefin-based resin foam and further forming a surface-treated layer of a polar polymer on the above-mentioned layer (see Patent Document 2). Furthermore, there have been also proposed a foam whose surface is treated with a polychloroprene-based adhesive composition (see Patent Document 3), a foam having a layer easily soluble in water (polyvinyl alcohol layer or the like) provided on the surface of the foam (see Patent Document 4) and the like. These are all produced by laminating a different material on the foam, and the physical properties of the foam may be thereby changed, and the production process is complicated.

When a carrier tape having a weak pressure-sensitive adhesive force is used for the purpose of preventing breakage in peeling, there may occur a problem in that the tape may be out of the position thereof during working since there exist fine foams in the surface of a resin foam and therefore the adhering area is not enough, thereby lowering a dimensional stability (shape stability); and another problem is that the foamed member is peeled away from a carrier tape before it is peeled off from the supporting board in building the foamed member into a structure being worked, and therefore the construction with the foamed member could not be attained.

Patent Document 1: JP-A-9-131822

Patent Document 2: JP-A-2003-136647

Patent Document 3: JP-A-5-24143

Patent Document 4: JP-A-10-37328

### SUMMARY OF THE INVENTION

Therefore, an object of the invention is to provide a resin foam excellent in workability and conveyability while held by a carrier tape, and capable of retarding or preventing foam breakage at the time when the resin foam is peeled from a carrier tape, even though the resin foam has a high expansion ratio, and is to provide a foamed member laminate including the resin foam, and an electric/electronic device including the resin foam.

As a result of extensive studies for solving the above problems, the present inventors have found that, when a specific surface layer is provided in a resin foam and when the surface coating ratio is controlled, then foam breakage can be suppressed or prevented in peeling the resin foam from a carrier tape and further the workability and the conveyability of the resin foam as held by a carrier tape are excellent. The invention has been completed on the basis of these findings.

Specifically, the invention provides a resin foam including a foam layer and a surface layer, in which the foam layer has a same composition as the surface layer, and the surface coating ratio of the surface layer defined by the following formula (1) is 40% or more.

$$Surface Coating Ratio ( \% ) = \frac{[ ( Area of surface ) - ( Area of pores existing in surface ) ]}{( Area of surface )} \times 100 \qquad ( 1 )$$

Further, the invention provides the resin foam, in which the foam layer has an apparent density of 0.20 g/cm³ or less.

Further, the invention provides the resin foam, in which a resin constituting the resin foam is a thermoplastic resin.

Further, the invention provides the resin foam, in which the thermoplastic resin is a polyolefin resin.

Further, the invention provides the resin foam, in which the surface layer is formed through a hot melt treatment.

Further, the invention provides the resin foam, in which a temperature for the hot melt treatment is not lower than a temperature defined by [(softening point or melting point of the resin constituting the resin foam)−15° C.].

Further, the invention provides the resin foam, which is produced through a process of impregnating a resin composition including the resin with a high-pressure gas, followed by reducing the pressure.

Further, the invention provides the resin foam, in which the gas is an inert gas.

Further, the invention provides the resin foam, in which the inert gas is carbon dioxide.

Further, the invention provides the resin foam, in which the high-pressure gas is in a supercritical state.

Further, the invention provides the resin foam, which has a closed cell structure or a semi-interconnected semi-closed cell structure. Further, the invention provides the resin foam, in which a surface of the surface layer has a lightness L* of 33.0 or less.

Further, the invention provides a foamed member including the resin foam.

Further, the invention provides the foamed member having the surface layer on one side of the foam layer and having a pressure-sensitive adhesive layer on the other side thereof.

Further, the invention provides the foamed member, in which the pressure-sensitive adhesive layer is an acrylic pressure-sensitive adhesive layer.

Further, the invention provides the foamed member being used in electric/electronic devices.

Further, the invention provides a foamed member laminate having a constitution where the resin foam is supported on a carrier tape having a substrate and a pressure-sensitive adhesive layer on at least one surface of the substrate, in which the resin foam is stuck to the carrier tape in a form of contacting the surface layer with the pressure-sensitive adhesive layer of the carrier tape.

Further, the invention provides an electric/electronic device including a foamed member for electric/electronic devices.

The resin foam of the invention has the constitution as above, and therefore, even though it has a high expansion ratio, foam breakage can be suppressed or prevented in peeling it from a carrier tape, and it is excellent in characteristics with a carrier tape such as workability and conveyability while held by a carrier tape.

### BRIEF DESCRIPTION OF THE DRAWING

FIG. 1 is a chart showing FT-IR patterns in Example 1.

### DETAILED DESCRIPTION OF THE INVENTION

### (Resin Foam)

The resin foam of the invention includes at least a foam layer and a surface layer, in which the foam layer and the surface layer have the same composition and the surface coating ratio of the surface layer defined by the following formula (1) is 40% or more. The surface coating ratio defined by the formula (1) may be referred to simply as “surface coating ratio”.

$$Surface Coating Ratio ( \% ) = \frac{[ ( Area of surface ) - ( Area of pores existing in surface ) ]}{( Area of surface )} \times 100 \qquad ( 1 )$$

In the invention, the surface layer of which the surface coating ratio (defined by the formula (1)) is 40% or more may be referred to as “specific surface layer”.

The surface layer is a layer region having a height of 20 μm from the surface of the resin foam, and differing from the foam layer, this is a layer part in which the foams are crushed and which has a nonuniform foam structure and has a dense structure.

The foam layer is a part having a structure where foams are uniformly distributed, and this is a layer part that occupies almost all the resin foam.

In the invention, the apparent density of the foam layer may be suitably defined in accordance with the intended use, but is preferably 0.20 g/cm³ or less (more preferably at 0.15 g/cm³ or less, even more preferably 0.13 g/cm³ or less). The lower limit of the apparent density of the resin foam is preferably 0.02 g/cm³ or more (more preferably 0.03 g/cm³ or more). When the apparent density of the foam layer exceeds 0.20 g/cm³, it may cause some disadvantages in that the foam formation is insufficient and the resin foam may lose flexibility. On the other hand, when it is less than 0.02 g/cm³, it is unfavorable since the strength of the resin foam may greatly lower.

In the resin foam of the invention, the surface layer and the foam layer have the same composition. “The same composition” includes “the same or almost the same”, and “almost the same” means that the main polymer of the resin that constitutes the resin foam is the same.

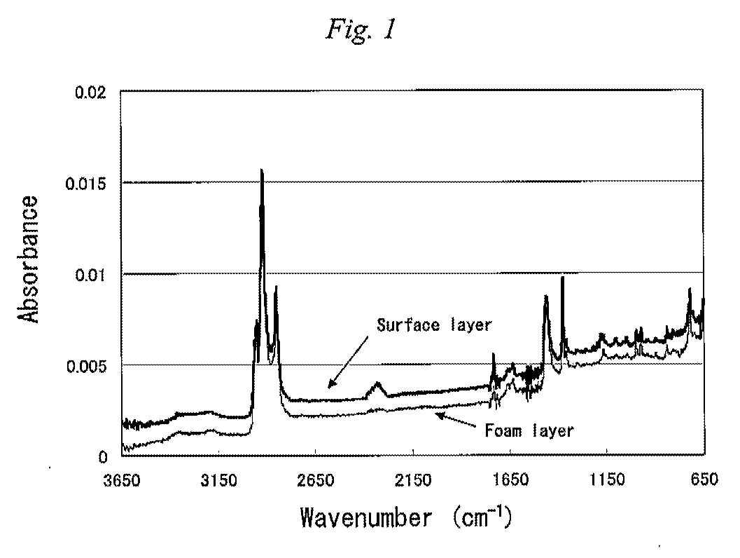

For example, almost the same composition of the surface layer and the foam layer can be confirmed in the chart of FT-IR analysis of the surface of the surface layer and an arbitrary cross section of the foam layer, in which the main absorptions of the two are compared with each other. When the main absorptions of the two are the same, then this means that the composition of the surface layer and that of the foam layer are almost the same (see FIG. 1). The above “arbitrary cross section of the foam layer” is the cross section thereof in the direction perpendicular to the thickness direction of the foam layer.

The resin foam of the invention may be so designed that it has the specific surface layer on one side of the foam layer, or it has the specific surface layer on both sides of the foam layer. In case where the resin foam of the invention is so designed that it has the specific surface layer on one side of the foam layer, the side thereof opposite to the specific surface layer may be a face provided by any other surface layer (a surface layer that is not the specific surface layer), or a face provided by the foam layer. Not specifically limited, the shape of the resin foam of the invention includes, for example, sheet-like, tape-like, film-like and other forms.

In the surface of the specific surface layer of the resin foam of the invention, the area of the pores existing in the surface of the foam (the area of the pores occupying the foam surface) is small, and therefore the contact area thereof to a carrier tape can be enlarged. In addition, since the resin foam of the invention has the surface layer, it has a high surface strength along with the characteristics (e.g., elongability, flexibility) of the resin foam. Accordingly, a carrier tape may be used for the resin foam of the invention when the resin foam is worked or conveyed, and in such a case, the resin foam of the invention exhibits good characteristics with the carrier tape. Concretely, when the specific surface layer side of the resin foam is stuck to a carrier tape and when the resin foam is worked or conveyed while kept held by the carrier tape, and thereafter when the resin foam is peeled from the carrier tape, the resin foam can be readily peeled from the carrier tape at the interface therebetween without causing foam breakage inside the foam layer. In addition, the specific surface layer of the resin foam exhibits a sufficient adhesive force to such a degree that the carrier tape is not peeled from it during working or conveyance. Therefore, in working or conveyance of the resin foam while kept held by a carrier tape, the action of the carrier tape to support the resin foam is stable, therefore not causing working failure or conveyance failure of the resin foam. As the carrier tape, any general carrier tape can be widely used, and for example, the carrier tape mentioned below may be used.

In the specific surface layer of the resin foam of the invention, when the value of the surface coating ratio is larger, then the contact area in sticking a carrier tape to the specific surface layer side of the resin foam can be larger, and the resin foam can exhibit a higher peeling force to the carrier tape; and therefore, the surface coating ratio is 40% or more, preferably 43% or more, more preferably 45% or more. In the invention, when the surface coating ratio is less than 40%, then the peeling force to a carrier tape is low; and in such a case, when the resin foam is worked or conveyed while kept held by a carrier tape, the action of the carrier tape supporting the resin foam may be unstable. The surface coating ratio of 100% means the absence of pores in the foam surface.

From the viewpoint that the resin foam of the invention can keep high flexibility in use under compression, the surface coating ratio of the specific surface layer is preferably 97% or less, more preferably 95% or less, even more preferably 90% or less.

L* (lightness) of the surface of the specific surface layer of the resin foam of the invention is preferably 33.0 or less from the viewpoint that the surface layer can have a sufficient pressure-sensitive adhesive force to a carrier tape and a sufficient surface strength, more preferably 32.0 or less, even more preferably 31.0 or less.

L* (lightness) is one of color attributes, and indicates the degree of shaddock of a color. A higher lightness value means an increased color lightness. L* (lightness) of 100 indicates a white color; and that of 0 indicate a black color. In case where the surface of a resin foam has a large number of fine pores, there occurs irregular reflection on the surface and the lightness of the resin foam tends to increase.

As described in the above, the resin foam of the invention may be worked or conveyed while its specific surface layer side is stuck to a carrier tape and while it is kept held by the carrier tape; and in conveying or working the resin foam in such a manner, the action of the carrier tape to support the resin foam has relation to the phenomenon of peeling at a low speed, and the surface layer must have a sufficient adhesive force to such a degree that it does not peel during working or conveyance [for example, the pressure-sensitive adhesive force measured in peeling under the condition of 23° C., 50 RH %, a tension rate of 0.3 m/min, and a peeling angle of 180° (low-speed peeling condition) is 0.30 N/20 mm or more, preferably 0.35 N/20 mm or more].

The specific surface layer side of the resin foam of the invention is stuck to a carrier tape, and while kept supported by the carrier tape, the resin foam is worked and conveyed, and thereafter it is peeled from the carrier tape; and the action in peeling the resin foam from the carrier tape has relation to the phenomenon of peeling at a high speed, and in peeling at a high speed (high-speed peeling, for example, in a case where the tension rate is 10 m/min), the resin foam must be peeled from the carrier tape in a mode of interfacial peeling where the two are peeled from each other at the interface therebetween. Further, when the resin foam is peeled from a carrier tape, foam breakage must be suppressed or prevented. Accordingly, the high-speed peeling force of the specific surface layer of the resin foam to the carrier tape [the pressure-sensitive adhesive force measured by peeling the two under a high-speed peeling condition (for example, at 23° C., 50 RH %, a tension rate of 10 m/min, and a peeling angle of 180°)] is preferably 0.25 N/20 mm or less, more preferably 0.20 N/20 mm or less.

Further, since the resin foam of the invention has the specific surface layer, it exhibits excellent reworkability. Concretely, for example, when the resin foam of the invention is stuck to a subject under compression to 50%, and kept aged as such at 50° C. for 7 days, the resin foam can be readily peeled from the subject without being broken. The reworkability means that, in a case where the resin foam (foamed member) is built in an electric/electronic device as a dust-proof material or a sealant material therein, it does not stick to the resin face or the metal face of the device housing or to the glass face of the image display panel, but can be readily peeled off. When the resin foam (foamed member) sticks to the surface of the subject such as that mentioned above, the foamed member may be broken in taking apart the device for maintenance or the like, and if so, it could no more function as the dust-proof material or the sealant material. In addition, in case where the resin foam (foamed member) could not be readily peeled from the subject, separate collection of the individual parts would be difficult in disassembling the structure, and material recycling would be thereby suppressed. Accordingly, the resin foam of the invention preferably has excellent reworkability.

As described in the above, the resin foam of the invention includes, as the indispensable constitutive elements, the foam layer and the specific surface layer. Not specifically limited, it is desirable that the resin foam of the invention is produced, for example, by foaming and shaping a resin composition that contains a resin to be the material of the resin foam, thereby giving a foamed structure, and then forming the specific surface layer on the foamed structure. In the preferred method, the foam layer is formed while the specific layer is formed on the foamed structure.

In the invention, as the material of the resin foam, a thermoplastic resin (thermoplastic polymer) is preferable. As the thermoplastic resin, not specifically limited, any and every polymer which exhibits thermal plasticity and into which a high-pressure gas can be impregnated. Examples of the thermoplastic resin includes polyolefin resins such as low-density polyethylene, middle-density polyethylene, high-density polyethylene, linear low-density polyethylene, polypropylene, ethylene/propylene copolymer, copolymer of ethylene or propylene with any other α-olefin (e.g., butene-1, pentene-1, hexene-1,4-methylpentene-1), copolymer of ethylene with any other ethylenic unsaturated monomer (e.g., vinyl acetate, acrylic acid, acrylate, methacrylic acid, methacrylate, vinyl alcohol); styrenic resins such as polystyrene, acrylonitrile/butadiene/styrene copolymer (ABS resin); polyamide resins such as 6-nylon, 66-nylon, 12-nylon; polyamidimides; polyurethanes; polyimides; polyether imides; acrylic resins such as polymethyl methacrylate; polyvinyl chloride; polyvinylidene chloride; alkenyl aromatic resins; polyester resins such as polyethylene terephthalate, polybutylene terephthalate; polycarbonates such as bisphenol A polycarbonate; polyacetals; polyphenylene sulfide, etc. Such thermoplastic resins may be used alone or in combination thereof. In case where the thermoplastic resin is a copolymer, it may have any morphology of a random copolymer or a block copolymer.

As the thermoplastic resin, a polyolefin resin is preferably used here. The polyolefin resin is preferably a resin of a type having a broad molecular weight distribution and having a shoulder on the high-molecular side, or a slightly-crosslinked resin (a resin of a type crosslinked a little), or a long chain-branched resin.

Preferably in the invention, the thermoplastic resin is used along with a rubber component and/or a thermoplastic elastomer component. The proportion of the rubber component and/or the thermoplastic elastomer component is not specifically limited. The blend ratio of the mixture of the polyolefin resin as the thermoplastic resin, and the rubber component and/or the thermoplastic elastomer component (% by weight) may be, for example, such that the former/the latter is from 1/99 to 99/1, but preferably from 10/90 to 90/10, more preferably from 20/80 to 80/20. In the mixture of the thermoplastic resin, and the rubber component and/or the thermoplastic elastomer component, when the proportion of the rubber component and/or the thermoplastic elastomer component is less than 1% by weight, then the cushionability of the resin foam may lower; but on the other hand, when it is more than 99% by weight, then gas leakage may often occur in foaming and a highly-expanded foam may be difficult to obtain.

Not specifically limited, the rubber component or the thermoplastic elastomer component may be any one having a rubber elasticity and capable of being foamed, and includes, for example, natural or synthetic rubbers such as natural rubber, polyisobutylene, polyisoprene, chloroprene rubber, butyl rubber, nitrile rubber; as well as various thermoplastic elastomers, such as olefin elastomers, e.g., ethylene/propylene copolymer, ethylene/propylene/diene copolymer, ethylene/vinyl acetate copolymer, polybutene, chloropolyethylene; styrenic elastomers, e.g., styrene/butadiene/styrene copolymer, styrene/isoprene/styrene copolymer, and their hydrogenated derivatives; polyester elastomers; polyamide elastomers; polyurethane elastomers. These rubber components and thermoplastic elastomer components may be used alone or in combination thereof. The rubber components and the thermoplastic elastomer components have, for example, a glass transition temperature of not higher than room temperature (for example, 20° C. or less), and therefore, when the resin foam of the invention is worked into a foamed member (e.g., dust-proof member, sealant member), it exhibits extremely excellent flexibility and shape followability.

As the rubber component and/or the thermoplastic elastomer component to be used along with the thermoplastic resin, preferred is an olefin elastomer. The olefin elastomer generally has a microphase-separated structure of an olefin resin ingredient such as polyethylene or polypropylene and an olefin rubber ingredient such as ethylene-propylene rubber or ethylene-propylene-diene rubber, in which the constitutive ingredients may be physically dispersed or may be dynamically heat-treated in the presence of a crosslinking agent, and this is well compatible with the polyolefin resin used here as the thermoplastic resin.

The resin foam of the invention may further contain powder particles. Powder particles exhibit the function as a foam nucleating agent in foam shaping. Accordingly, incorporating powder particles produces a resin foam in a good foam state. As the powder particles, for example, herein usable are powdery talc, silica, alumina, zeolite, calcium carbonate, magnesium carbonate, barium carbonate, zinc oxide, titanium oxide, aluminium oxide, magnesium oxide, mica, clay such as montmorillonite, as well as carbon particles, glass fibers, carbon tubes. One or more different types of such powder particles may be used alone or in combination thereof.

In the invention, as the powder particles, preferred are powdery particles having an average particle size (particle diameter) of from 0.1 to 20 μm. Powder particles having an average particle size of less than 0.1 μm could not sufficiently function as a nucleating agent; but those having a particle size of more than 20 μm are unfavorable as causing gas leakage in foam shaping.

Not specifically limited, the amount of the powder particles to be added may be suitably selected, for example, from a range of from 0.1 to 150 parts by weight (preferably from 1 to 130 parts by weight, more preferably from 2 to 50 parts by weight) relative to the total amount, 100 parts by weight of the thermoplastic resin and the rubber component and/or the thermoplastic elastomer component. When the amount of the powder particles is less than 0.1 parts by weight relative to 100 parts by weight of the thermoplastic resin, then a uniform foam is difficult to produce; but on the other hand, when it is more than 150 parts by weight, the viscosity of the resin composition may extremely increase and there may occur gas leakage in foam shaping to detract from the foaming characteristics.

The resin foam is formed of a thermoplastic resin, and is therefore combustible. Accordingly, in case where the foamed member including the resin foam of the invention is used in applications indispensably requiring flame retardancy, such as applications of electric/electronic devices, preferably, flame-retardant powder particles (e.g., various powdery flame retardants) are incorporated in the resin foam. A flame retardant may also be incorporated along with powder particles not having an ability of flame retardation.

In the invention, an inorganic flame retardant is preferred as the powdery flame retardant. The inorganic flame retardant may be, for example, a bromine-based flame retardant, chlorine-based flame retardant, phosphorus-based flame retardant, or an antimony-based flame retardant; however, chlorine-based flame retardants and bromine-based flame retardants generate, when fired, gaseous substances that are harmful to human bodies and are corrosive to devices, and phosphorus-based flame retardants and antimony-based flame retardants involve problems of harmfulness and explosion. Accordingly, preferred for use herein are non-halogen/non-antimony inorganic flame retardants. Non-halogen/non-antimony inorganic flame retardants include, for example, aluminium hydroxide, magnesium hydroxide, and hydrated metal compounds such as magnesium oxide/nickel oxide hydrate, magnesium oxide/zinc oxide hydrate. The metal oxide hydrates may be surface-treated. These flame retardants may be used alone or in combination thereof.

In case where a flame retardant is used, its amount is not specifically limited. For example, the amount may be suitably selected from a range of from 5 to 130 parts by weight (preferably from 10 to 120 parts by weight) relative to the total amount, 100 parts by weight of the thermoplastic resin and the rubber component and/or the thermoplastic elastomer component. When the amount of the flame retardant is too small, the effect of flame retardation is poor; but on the contrary, when it is too large, a highly-expanded foam may be difficult to obtain.

Various additives may be incorporated in the resin composition, if desired. The type of the additive is not specifically limited, and various additives generally used in foam shaping of resin may be used. Concretely, the additives include, for example, a foam nucleating agent, a crystal nucleating agent, a plasticizer, a lubricant, a colorant (pigment, dye, etc.), a UV absorbent, an antioxidant, an aging inhibitor, a filler, a reinforcing agent, an antistatic agent, a surfactant, a tension improver, a shrinkage inhibitor, a flowability improver, a clay, a vulcanizing agent, a surface-treating agent, other various flame retardants than flame-retardant powders. The amount of the additive to be added may be suitably selected within a range not detracting from the formation of foams, and it may be an ordinary amount thereof generally used in shaping thermoplastic resins.

As described in the above, the resin foam of the invention is produced generally by foaming and shaping a resin composition to obtain a foamed structure and forming the specific surface layer on the foamed structure. The resin composition is prepared by mixing the resin to constitute the resin foam and additives optionally added thereto.

The foaming method for producing the foamed structure by foaming and shaping a resin composition to obtain the resin foam of the invention is not specifically limited, for which, for example, employable is any ordinary method of a physical method or a chemical method. In an ordinary physical method, a low-boiling point liquid (foaming agent) of chlorofluorocarbons, hydrocarbons or the like is dispersed in a resin, and then heated to vaporize the foaming agent to thereby form cells. In an ordinary chemical method, cells are formed by the vapor generated through thermal decomposition of a compound (foaming agent) added to a resin. However, the ordinary physical method involves some problems of flammability and toxicity of the substance to be used as the foaming agent, and negative influences on the environment such as ozone depletion. On the other hand, in the ordinary chemical method, the residue of the foaming gas remains in the foam, and therefore for use in electric devices that requires high-level non-contamination, the method involves problems of contamination with the corrosive gas or with the impurities remaining in the gas. Moreover, in any of these physical method and chemical method, a microcell structure is difficult to form, and in particular, it is said that, according to such methods, microcells not larger than 300 μm are especially difficult to form.

Accordingly, in the invention, as the foaming method to be used in foaming and shaping a resin composition to produce the resin foam, preferably employed is a method of using a high-pressure gas as the foaming agent from the viewpoint that a foamed structure having a small cell diameter and having a high cell density is easy to produce. More preferred is a method of using a high-pressure inert gas as the foaming agent. The inert gas means a gas inert to the resin in the resin composition. Specifically, it is especially preferable that the cell structure (foamed structure) of the resin foam of the invention is produced according to the method of using a high-pressure inert gas as the foaming agent.

Concretely, preferred embodiments of the method of foaming a resin composition with a high-pressure gas serving as a foaming agent and shaping it to obtain a foamed structure in producing the resin foam of the invention include a method including a step of impregnating a resin composition with a high-pressure gas, followed by reducing the pressure, a method including a step of impregnating an unfoamed shaped product of a resin composition with a high-pressure gas, followed by reducing the pressure, and a method including a step of impregnating a melted resin composition with a gas (e.g., inert gas) under pressure, followed by shaping it with reducing the pressure. Specifically, it is preferable that the cell structure (foamed structure) of the resin foam of the invention is formed through a step of impregnating a resin composition with a high-pressure gas and then reducing the pressure.

Not specifically limited, the inert gas may be any one inert to resin and capable of being impregnated into resin, and includes, for example, carbon dioxide, nitrogen gas and air. These gases may be mixed for use herein. Of those, preferred is carbon dioxide as its impregnation amount into resin for use as the material for the foam is large and its impregnation speed is high.

From the viewpoint of further increasing the impregnation speed thereof into a resin composition, the high-pressure gas (preferably inert gas, more preferably carbon dioxide) is preferably in a supercritical state. In the supercritical state, the gas solubility in resin increases, and high-concentration gas impregnation into resin may be possible. In rapid pressure reduction after gas impregnation, a larger number of cell nuclei may be formed since the gas may be impregnated at a high concentration as so mentioned in the above, and accordingly, a larger number of microcells can be formed since the density of the cells to be grown from the cell nuclei can be larger even though the porosity is the same. The critical temperature of carbon dioxide is 31° C. and the critical pressure thereof is 7.4 MPa.

In producing a foamed structure by impregnating a high-pressure gas into a resin composition, the resin composition may be previously shaped into a suitable form such as a sheet to be an unfoamed shaped resin product (unfoamed shaped product), and thereafter a high-pressure gas is impregnated into this unfoamed shaped resin product, and the pressure is released for foaming (batch process); or the resin composition may be kneaded under pressure along with a high-pressure gas, and shaped with simultaneously releasing the pressure to thereby attain both shaping and foaming at the same time (continuous process). In that manner, a high-pressure gas may be impregnated into the previously-shaped foamed resin product, or a high-pressure gas may be impregnated into a melted resin composition under pressure and then shaped with reducing the pressure.

Concretely, the batch process of preparing the unfoamed shaped resin product in producing the resin structure includes, for example, a method that includes shaping the resin composition including a resin, a rubber component and/or a thermoplastic elastomer component optionally therein, and powder particles and other additives also optionally therein by the use of an extruder such as a single-screw extruder or a twin-screw extruder; a method that includes uniformly kneading the same resin composition as above by the use of a kneading machine with a blade such as a roller-type, cam-type, kneader-type or Banbury-type mixer, followed by pressing it with a pressing machine such as a hot plate into a predetermined thickness; and a method that includes molding the composition with a compression molding machine. Anyhow, the resin composition may be shaped into a shaped product having a desired form and a thickness. Thus obtained, the unfoamed shaped resin product (shaped product of resin composition) is put into a pressure chamber (high-pressure chamber) and foamed through a process including a gas impregnation step of injecting (introducing) a high-pressure gas (especially, inert gas, more preferably carbon dioxide) into the chamber to thereby impregnate the high-pressure gas into the unfoamed shaped resin product, a pressure reduction step of releasing the pressure (generally to an atmospheric pressure) at the point when the high-pressure gas has been sufficiently impregnated into the resin product, thereby forming cell nuclei in the resin, and optionally (if desired), a heating step of heating it to grow the cell nuclei, thereby forming cells in the resin. The heating step may be omitted, and the cell nuclei may be grown at room temperature. After the cells are grown in the manner as above, if desired, the foamed structure may be rapidly cooled with cold water or the like whereby the shape thereof is fixed to obtain the intended foamed structure. Not specifically limited, the form of the unfoamed shaped resin product may be any of a roll form, a sheet form or the like. The high-pressure gas introduction may be attained continuously or discontinuously. Further, for the heating method for growing the cell nuclei, employable is any known or usual method of using a water bath, an oil bath, a hot roll, a hot air oven, far-IR rays, near-IR rays, microwaves, etc. Further, the unfoamed shaped resin product (unfoamed shaped product) to be foamed is not limited to a sheet product, but may have any other various forms (for example, columnar form) in accordance with the use thereof. The unfoamed shaped resin product to be foamed may be formed any other shaping methods except extrusion, pressing or injection molding.

On the other hand, in case where the foamed structure is produced according to a continuous process, for example, employable is a method that includes a kneading and impregnating step of kneading the resin composition including a resin, a rubber component and/or a thermoplastic elastomer component optionally therein, and powder particles and other additives also optionally therein by the use of an extruder such as a single-screw extruder or a twin-screw extruder, and at the same time sufficiently impregnating a high-pressure gas into the resin composition, and a shaping and pressure-reducing step of extruding the resin composition through the die arranged at the end of the extruder to release the pressure (generally to atmospheric pressure) to thereby simultaneously shape and foam the resin composition. As the case may be (or optionally), the method may further includes a heating step of growing the cells by heating. After the cells have been thus grown in the manner as above, if desired, the foamed structure may be rapidly cooled with cold water or the like whereby the shape thereof is fixed to obtain the intended foamed structure. In the above kneading and impregnating step and the shaping and pressure-reducing step, an injection molding machine may be used except the extruder. Further, any suitable method may be selected for producing the foamed structure having any other desired shape such as a sheet form, a columnar form or the like.

Not specifically limited, the amount of the gas to be mixed may be, for example, from 2 to 10% by weight or so relative to the total amount of the resin component in the resin composition. The gas amount to be added may be suitably controlled so as to obtain the desired density and the desired expansion ratio.

In the gas impregnation step in the batch process or the kneading and impregnation step in the continuous process, the pressure under which the gas is impregnated into the unfoamed shaped resin product or into the resin composition may be suitably selected in consideration of the type of the gas and the operability of the process; and for example, in case where an inert gas, especially carbon dioxide is used as the gas, its pressure is preferably 6 MPa or more (for example, from 6 to 100 MPa or so), more preferably 8 MPa or more (for example, from 8 to 100 MPa or so). When the gas pressure is lower than 6 MPa, the cell growth in foaming may be too great and the cell diameter may increase too much; and if so, there may occur some disadvantage in that the dust-proof effect of the foamed structure may lower. This is because, when the pressure is low, the gas impregnation amount is relatively smaller than that under high pressure, and therefore the cell nuclei-forming speed is low and the number of the cell nuclei to be formed is small, and as a result, the gas amount per one cell increases on the contrary and the cell diameter increases enormously. In addition, in the pressure range lower than 6 MPa, the cell diameter and the cell density may greatly change only when the impregnation pressure is changed a little, and therefore, it is often difficult to control the cell diameter and the cell density.

In the gas impregnation step in the batch process or the kneading and impregnation step in the continuous process, the temperature at which the high-pressure gas is impregnated into the unfoamed shaped resin product or into the resin composition varies depending on the type of the gas and the resin to be used, and may be therefore selected in a broad range. In consideration of the operability in the process, for example, the temperature may be from 10 to 350° C. or so. For example, in case where a high-pressure gas is impregnated into a sheet-like, unfoamed shaped resin product, the impregnation temperature may be from 10 to 200° C. (preferably from 40 to 200° C.). In the continuous process, the temperature at which a high-pressure gas is impregnated into the resin composition is generally from 60 to 350° C. or so. In case where carbon dioxide is used as the high-pressure gas, the temperature in impregnation (impregnation temperature) is preferably 32° C. or more (more preferably 40° C. more) for keeping the supercritical state thereof.

In the pressure-reducing step, the pressure-reducing speed is not specifically limited; however, for forming uniform microcells, the pressure is preferably from 5 to 300 MPa/sec or so. The heating temperature in the heating step may be, for example, from 40 to 250° C. (preferably from 60 to 250° C.) or so.

According to the production method for a foamed structure, there can be produced a foamed structure having a high expansion ratio, and the method has the advantage in that it can give a thick resin foam. For example, in case where a foamed structure is produced according to a continuous process, the gap of the die to be fitted to the end of the extruder must be as narrow as possible (generally from 0.1 to 1.0 mm) in order that the pressure inside the extruder is kept in the kneading and impregnation step. Accordingly, for obtaining a thick foamed structure, the resin composition extruded out through the narrow gap must be foamed at a high expansion ratio; however, heretofore, a high expansion ratio could not be attained, and therefore the foamed structure to be produced is limited to a thin one (for example, having a thickness of from 0.5 to 2.0 mm or so). As opposed to this, the foamed structure to be produced by the use of a high-pressure gas can be continuously formed to have a final thickness of from 0.50 to 5.00 mm. In order to obtain such a thick foamed structure, the relative density of the foamed structure (density after foamed/density in unfoamed state) is preferably from 0.02 to 0.30 (more preferably from 0.05 to 0.25). When the relative density is more than 0.30, the foaming may be insufficient and the foamed structure may be defective in point of the flexibility; but when less than 0.02, it is unfavorable since the strength of the foamed structure may greatly lower.

In the invention, the apparent density of the foam layer (foamed structure) is preferably 0.20 g/cm³ or less, more preferably 0.15 g/cm³ or less, even more preferably 0.13 g/cm³ or less, as mentioned above. The lower limit of the apparent density of the resin foam is preferably 0.02 g/cm³ or more, more preferably 0.03 g/cm³ or more.

The apparent density of the foam layer may be controlled, for example, by controlling the amount and the pressure of the gas to be impregnated into the resin composition and thereby controlling the expansion ratio in producing the resin foam.

The apparent density of the foam layer may be determined as follows: Using a blanking blade having a size of 40 mm×40 mm, the resin foam is blanked, and the dimension of the resulting sample is measured. Using a 1/100 dial gauge of which the measuring terminal has a diameter (φ) of 20 mm, the thickness of the sample is measured. From the data, the volume of the thermoplastic resin foam is computed. Next, the weight of the foam layer is measured with an even balance having a minimum scale value of at least 0.01 g. From these data, the apparent density (g/cm³) of the foam layer is computed.

Not specifically limited, the cell structure of the resin foam is preferably a closed cellular structure or a semi-interconnected semi-closed cell structure (composed of a closed cell structure and an interconnected cell structure mixed in a ratio not specifically limited); and more preferably, the cell structure of the foam layer of the resin foam has a closed cell structure moiety in a ratio of 40% or less, even more preferably 30% or less, from the viewpoint of the flexibility of the layer. The cell structure can be controlled, for example, by controlling the amount and the pressure of the gas to be impregnated into the resin composition and thereby controlling the expansion ratio in producing the resin foam to be mentioned below.

The thickness, the relative density and the apparent density of the foamed structure can be controlled, for example, by suitably selecting and regulating the operation condition such as the temperature, the pressure and the time in the gas impregnation step and the kneading and impregnation step, the operation condition such as the pressure-reducing speed, the temperature and the pressure in the pressure-reducing step and the shaping and pressure-reducing step, and the heating temperature in the heating step after the pressure reduction or after the shaping and pressure reduction, depending on the type of the gas to be used, and the type of the thermoplastic resin and the rubber component and/or the thermoplastic elastomer component.

The resin foam of the invention is preferably produced by first preparing the foamed structure through foaming and shaping of a resin composition, and then forming the specific surface layer on the foamed structure, as described above.

The treatment of forming the specific surface layer is not specifically limited so far as the foam layer and the specific surface layer could have the same composition. For example, the treatment includes hot melt treatment, coating with resin, adhesion of a resin layer, sticking of a resin film layer via a pressure sensitive adhesive layer. Above all, hot melt treatment is preferred in which the compatibility with other materials may not be taken into consideration and the thickness change is small.

Not specifically limited, the hot melt treatment includes pressing with a hot roll, laser irradiation treatment, contact melting treatment on a hot roll, flame treatment.

For pressing with a hot roll, preferably used is a hot laminator. The material of the roll includes rubber, metal, fluororesin (e.g., Teflon™).

The temperature in hot melt treatment is not specifically limited. From the viewpoint of efficiently forming the specific surface layer, it is preferably not lower than the temperature lower by 15° C. than the softening point or the melting point of the resin to constitute the resin foam, more preferably not lower than the temperature lower by 12° C. than the softening point or the melting point of the resin to constitute the resin foam, and is preferably not higher than the temperature higher by 20° C. than the softening point or the melting point of the resin to constitute the resin foam, more preferably not higher than the temperature higher by 10° C. than the softening point or the melting point of the resin to constitute the resin foam. When the temperature in hot melt treatment is lower than the temperature lower by 15° C. than the softening point or the melting point of the resin to constitute the resin foam, then the melting of the surface of the foam structure could not go on and the intended specific surface layer could not be formed. On the other band, when the temperature in hot melt treatment is higher than the temperature lower by 20° C. than the softening point or the melting point of the resin to constitute the resin foam, then the foamed structure may be shrunk and there may occur problems of shrinking, etc.

Though depending on the treatment temperature, the time for hot melt treatment is, for example, preferably from 0.1 seconds to 10 seconds or so, more preferably from 0.5 seconds to 7 seconds or so. When the time is too short, then the melting of the surface of the foamed structure could not go on and the intended specific surface layer could not be formed. On the other hand, when the time is too long, then the foamed structure may be shrunk and them may occur problems of shrinking, etc.

In coating with resin, or adhesion of a resin layer, or sticking of a resin film layer via a pressure-sensitive adhesive layer, preferably used is the above-mentioned resin composition; used in producing the foamed structure, from the viewpoint of easiness in attaining the same composition and easiness in working operation.

The thickness and the shape of the resin foam of the invention are not specifically limited, and may be suitably selected in accordance with the intended use thereof. For example, the thickness of the resin foam may be selected from a range of from 0.2 to 5 mm, preferably from 0.3 to 3 mm or so.

In general, the resin foam may be worked into various shapes in accordance with the devices in which it is used. In this case, the resin foam may be worked or conveyed while it is kept stuck to a carrier tape (that is, while the resin foam is kept held by a carrier tape as a foamed member laminate).

A pressure-sensitive adhesive layer may be formed on the resin foam. In case where the resin foam has a pressure-sensitive adhesive layer, the pressure-sensitive adhesive layer may be provided on the specific surface layer, or the pressure-sensitive adhesive layer may be provided on any other surface layer, or the pressure-sensitive adhesive layer may be provided on the foam layer, with no specific limitation.

The resin foam has a good foamed structure, and therefore by working it into a predetermined shape, it may be favorably used as a dust-proof member, a sealant member, an impact absorber, an acoustic insulator, a buffer or the like that is used in fitting (installing) various members or parts in predetermined sites.

### (Foamed Member)

The foamed member is a member formed of the resin foam, and is indispensably so designed that it can be held by a carrier tape via the specific surface layer of the resin foam. In other words, the foamed member is formed of the resin foam, and is so designed that the specific surface layer of the resin foam is the outermost layer. Having the constitution, the foamed member exhibits good characteristics to carrier tape (carrier tape-compatible characteristics) such as workability using carrier tape, conveyability with carrier tape, foam retention with no breakage in peeling from carrier tape, and peelability from carrier tape.

Concretely, the foamed member may be composed of the resin foam alone, or may be so designed that any other layer or substrate (especially a pressure-sensitive adhesive layer or the like) is laminated on the other surface of the resin foam (in case where only one surface of the foamed member is the specific surface layer, the additional layer or substrate is laminated on the other surface thereof; or in case where both surfaces of the foamed member are the specific surface layers, the additional layer or substrate is laminated on any one of the surfaces); and when the foamed member is so worked as to have a pressure-sensitive adhesive layer formed thereon, then, for example, a supporting board may be stuck to it, or it may be fixed to or temporarily fitted to a subject.

The pressure-sensitive adhesive for forming the pressure-sensitive adhesive layer is not specifically limited, for which, for example, any known pressure-sensitive adhesive may be suitably selected from acrylic pressure-sensitive adhesives, rubber pressure-sensitive adhesives (natural rubber pressure-sensitive adhesives, synthetic rubber pressure-sensitive adhesives, etc.), silicone pressure-sensitive adhesives, polyester pressure-sensitive adhesives, urethane pressure-sensitive adhesives, polyamide pressure-sensitive adhesives, epoxy pressure-sensitive adhesives, vinyl alkyl ether pressure-sensitive adhesives, fluorine-containing pressure-sensitive adhesives, etc. The pressure-sensitive adhesive may be a hot-melt pressure-sensitive adhesive. One or more such pressure-sensitive adhesives may be used here either singly or as combined. The pressure-sensitive adhesive may be of any type, including emulsion pressure-sensitive adhesives, solvent pressure-sensitive adhesives, oligomer pressure-sensitive adhesives, solid pressure-sensitive adhesives. Above all, preferred are acrylic pressure-sensitive adhesives as they are free from a problem of contamination of subjects.

The pressure-sensitive adhesive layer may be formed according to a known or usual forming method. For example, there may be mentioned a method of applying a pressure-sensitive adhesive onto a predetermined site or face (coating method), and a method including applying a pressure-sensitive adhesive onto a release film such as a release liner to form a pressure-sensitive adhesive layer thereon, and transferring the pressure-sensitive adhesive layer onto a predetermined site or face (transfer method). In forming the pressure-sensitive adhesive layer, suitably used is a known or usual coating method (e.g., casting method, roll coating method, reverse coating method, doctor blade coating method).

The thickness of the pressure-sensitive adhesive layer may be generally from 2 to 100 μm, preferably from 10 to 100 μm or so. The pressure-sensitive adhesive layer is preferably thinner, since it is more effective for preventing adhesion of dust and contaminants to the edge thereof. The pressure-sensitive adhesive layer may be a single layer or a laminate layer.

The pressure-sensitive adhesive layer may be formed on the foam via any other layer (underlayer). The underlayer includes, for example, a substrate layer (especially a film layer), a nonwoven fabric layer, any other pressure-sensitive adhesive layer, an interlayer, a subbing layer.

In case where the pressure-sensitive adhesive layer is formed on the other side of the foamed member, any other layer may be further formed thereon, or more concretely, a release film (separator) (e.g., release paper, release film), a substrate (e.g., paper substrate, fibrous substrate, metal substrate, plastic substrate such s PET film), or any other pressure-sensitive adhesive layer may be formed thereon.

The foamed member may be worked to have a desired shape or thickness, or may be worked into various shapes in accordance with the devices and instruments in which it is used. The foamed member is favorably used as a dust-proof member, a sealant member, an impact absorber, an acoustic insulator, a buffer or the like that is used in fitting (installing) various members or parts in predetermined sites.

### (Foamed Member Laminate)

The foamed member laminate is so designed that the resin foam or the foamed member is kept held by a carrier tape having a pressure-sensitive adhesive layer on at lest one surface of the substrate thereof, in which the resin foam is stuck to the carrier tape in such a manner that the specific surface layer thereof is kept in contact with the pressure-sensitive adhesive layer of the carrier tape. “Resin foam or foamed member” may be hereinafter expressed as “resin foam (foamed member)”.

In that manner, the foamed member laminate is so designed that the resin foam (foamed member) is kept stuck to the pressure-sensitive adhesive face of a carrier tape, and therefore the resin foam (foamed member) can be worked or conveyed while kept stuck to the pressure-sensitive adhesive face of the carrier tape; and moreover, since the specific surface layer of the resin foam is stuck to the pressure-sensitive adhesive face of the carrier tape, foam breakage may be suppressed or prevented in use of the resin foam (foamed member), and the resin foam (foamed member) can be peeled from the carrier tape with ease.

Using the foamed member laminate of the invention, the resin foam (foamed member) can be worked into a predetermined shape and then the resin foam (foamed member) can be peeled from the carrier tape, whereby the resin foam (foamed member) can be isolated. In the thus-isolated resin foam (foamed member), the resin foam (foamed member) is peeled from the carrier tape through interlayer peeling therebetween, and there occurs no foam breakage in the foamed structure. Accordingly, the isolated resin foam (foamed member) keeps a good cell structure and is worked into a desired shape. Therefore, the resin foam (foamed member) worked and isolated by the use of the foamed member laminate is useful as a dust-proof member, a sealant member, an impact absorber, an acoustic insulator, a buffer or the like that is used in fitting (installing) various members or parts in predetermined sites.

The carrier tape is not specifically limited, but it is important that the tape has a pressure-sensitive adhesive face. Also importantly, the carrier tape can exhibit a pressure-sensitive adhesive force (adhesive force) enough to hold the resin foam in working or conveying the resin foam, and on the other hand, it can exhibit a pressure-sensitive adhesive force (adhesive force) to such a degree that it can be readily peeled away from the resin foam without damaging or breaking the surface of the resin foam.

Accordingly, as the carrier tape, usable is a pressure-sensitive adhesive tape or sheet having a pressure-sensitive adhesive layer of various pressure-sensitive adhesives; and in particular, from the viewpoint of satisfying both the adhesiveness to and the peelability from the resin foam, preferred is a pressure-sensitive adhesive tape or sheet having an acrylic pressure-sensitive adhesive layer of an acrylic pressure-sensitive adhesive that includes an alkyl (meth)acrylate as the main ingredient thereof. The pressure-sensitive adhesive tape or sheet may have any constitution of a substrate-supported pressure-sensitive adhesive tape or sheet having a pressure-sensitive adhesive layer formed on at least one surface of the substrate thereof, or a substrateless pressure-sensitive adhesive tape or sheet formed of a pressure-sensitive adhesive layer alone.

Apart from acrylic pressure-sensitive adhesives, the pressure-sensitive adhesive to form the pressure-sensitive adhesive layer includes, for example, rubber pressure-sensitive adhesives (natural rubber pressure-sensitive adhesives, synthetic rubber pressure-sensitive adhesives, etc.), silicone pressure-sensitive adhesives, polyester pressure-sensitive adhesives, urethane pressure-sensitive adhesives, polyamide pressure-sensitive adhesives, epoxy pressure-sensitive adhesives, vinyl alkyl ether pressure-sensitive adhesives, fluorine-containing pressure-sensitive adhesives. The pressure-sensitive adhesive may be a hot melt pressure-sensitive adhesive. One or more such pressure-sensitive adhesives may be used here either singly or as combined. The pressure-sensitive adhesive may be of any type, including emulsion pressure-sensitive adhesives, solvent pressure-sensitive adhesives, oligomer pressure-sensitive adhesives, solid pressure-sensitive adhesives.

The substrate of the pressure-sensitive adhesive tape or sheet is not specifically limited, for which, for example, employable are any suitable sheet-like substances including plastic substrates such as plastic films or sheets; paper substrates such as paper; fibrous substrates such as fabrics, nonwoven fabrics, nets; metal substrates such as metal foils, metal sheets; rubber substrates such as rubber sheets; foams such as foamed sheets; their laminates (especially laminates of a plastic substrate and any other substrate, laminates of plastic films (or sheets)).

The thickness of the substrate and the pressure-sensitive adhesive layer in the pressure-sensitive adhesive tape or sheet that serves as the carrier tape is not specifically limited.

### (Foamed Member for Electric/Electronic Devices)

The resin foam or the foamed member of the invention keeps a good cell structure, and therefore, by working it into a predetermined shape, it may be favorably used as a dust-proof member, a sealant member, an impact absorber, an acoustic insulator, a buffer or the like that is used in fitting (installing) various members or parts in predetermined sites. In particular, it is favorably used even in fitting small-sized members or parts in thin-walled products.

The members or the parts capable of being fitted (installed) in devices by the use of the resin foam or the foamed member are not specifically limited, and may be, for example, various members or parts of electric/electronic devices. Members or parts of electric/electronic devices includes, for example, image display members (especially small-sized image display members) to be fitted in image display devices such as liquid-crystal displays, electroluminescent displays, plasma displays, as well as optical members or optical parts such as cameras or lenses (especially small-sized cameras and lenses) to be fitted in mobile communication devices such as portable telephones or portable information terminals.

In addition, the resin foam or the foamed member can be used as a dust-proof member for preventing toner from being leaked away from a toner cartridge. The toner cartridge capable of being fitted to a device by the use of the foamed member includes toner cartridges for use in image forming devices such as duplicators, printers.

### (Electric/Electronic Devices)

In the electric/electronic devices of the invention, the above-mentioned resin foam or foamed member is used. In the electric/electronic devices, the resin foam or the foamed member is used, for example, as a dust-proof member, a sealant member, an impact absorber, an acoustic insulator or a buffer. The electric/electronic devices are generally so designed that the members or the parts of the electric/electronic device are fitted (installed) in predetermined sites via the resin foam or the foamed member. Concretely, the electric/electronic devices include those in which image display devices such as liquid-crystal displays, electroluminescent displays or plasma displays as optical members or parts (especially, image display devices in which small-sized image display members are installed as optical members), as well as those in which cameras or lenses (especially small-sized cameras or lenses) are installed via the resin foam or the foamed member (e.g., mobile communication devices such as portable telephones, portable information terminals). The electric/electronic devices may be thinner than before, but their thickness and shape are not specifically limited.

### EXAMPLES

The invention is described in more detail with reference to the following Examples, by which, however, the invention should not be restricted at all.

### (Measurement of L* (Lightness))

A simplified spectral colorimeter (Nippon Denshoku Industries' “NF333”) was used.

### (Measurement of Surface Coating Ratio)

The surface coating ratio was computed according to the formula (1):

$$Surface Coating Ratio ( \% ) = \frac{[ ( Area of surface ) - ( Area of pores existing in surface ) ]}{( Area of surface )} \times 100 \qquad ( 1 )$$

The area of the foam surface, and the area of the pores existing in the foam surface were determined on the image of the sample surface taken with a microscope (Keyence's “VHX600”).

In observation with the microscope, side lighting was employed as the lighting method, and its lighting intensity was 17000 luxes. The magnification was 500-power.

As the camera additionally serving as lighting, used was a lighting built-in lens camera (Keyence's “OP72404”); and as the lens, used was a zoom lens (Keyence's “VH-Z100”).

The lighting was controlled with an illuminometer “Custom's “VHX600”).

### (Production Example 1 for Foamed Structure)

45 parts by weight of polypropylene [melt flow rate (MFR): 0.35 g/10 min], 55 parts by weight of a polyolefinic elastomer [melt flow rate (MFR): 6 g/10 min, JIS A hardness: 79°], 6 parts by weight of carbon black (Asahi Carbon's trade name “Asahi #35”), and 10 parts by weight of a powdery flame retardant, magnesium hydroxide (average particle size: 0.7 μm) were kneaded in a twin-screw extruder (by JSW) at 200° C., then extruded as strands, cooled with water, and shaped into pellets. The pellets had a softening point of 160° C.

The pellets were put into a single-screw extruder (by JSW), and carbon dioxide was injected thereinto under a pressure of 22 MPa (but 19 MPa after injection) at 220° C. After fully saturated with carbon dioxide, this was cooled to a temperature suitable for foaming, and then extruded out through the die to obtain a foam (foamed structure).

The foam had an apparent density of 0.05 g/cm³, and its thickness was 2.0 mm. The foam was sliced to obtain foam slices each having a thickness of 1.0 mm (this is referred to as “foamed structure A”).

### Example 1

Using a hot laminator of which the roll gap is adjustable (MCK's “MRK-6504”), the foamed structure A was processed for surface hot melt treatment under the condition of a gap of 1 mm, a roll temperature of 150° C. and a treating speed of 8 m/min, thereby obtaining a resin foam having a surface coating ratio of 49.2%.

### Example 2

A resin foam having a surface coating ratio of 62.1% was produced according to the same surface hot melt treatment as in Example 1, for which, however, the gap was changed to 0.9 mm.

### Example 3

A resin foam having a surface coating ratio of 64.6% was produced according to the same surface hot melt treatment as in Example 1, for which, however, the roll temperature was changed to 160° C.

### Example 4

A resin foam having a surface coating ratio of 75.4% was produced according to the same surface hot melt treatment as in Example 3, for which, however, the gap was changed to 0.9 mm.

### Example 5

A resin foam having a surface coating ratio of 83.7% was produced according to the same surface hot melt treatment as in Example 1, for which, however, the gap was changed to 0.8 mm.

### Example 6

A resin foam having a surface coating ratio of 88.9% was produced according to the same surface hot melt treatment as in Example 1, for which, however, the roll temperature was changed to 170° C.

### Comparative Example 1

The foamed structure A was used directly as it was. The foamed structure A had a surface coating ratio of 24.3%.

### Comparative Example 2

A resin foam having a surface coating ratio of 35.3% was produced according to the same surface hot melt treatment as in Example 1, for which, however, the roll temperature was changed to 140° C.

### (Evaluation 1)

Examples and Comparative Examples were tested or evaluated for the pressure-sensitive adhesive force and the presence or absence of foam breakage, according to the following test method or evaluation method. The results are shown in Table 1.

### (Pressure-Sensitive Adhesive Force)

The resin foam (width 20 mm×length 120 mm) was stored for at least 24 hours in an atmosphere having a temperature of 23±2° C. and a humidity of 50±5 RH % (the pretreatment condition is in accordance with JIS Z 0237), and a carrier tape having a width of 30 mm and a length of 120 mm (Nitto Denko's trade name “SPV-AM-500”, substrate-supported single-side pressure-sensitive adhesive tape in which the substrate is a PET substrate) was stuck thereto in such a manner that the pressure-sensitive adhesive layer surface of the carrier tape could face the hot melt-treated surface of the resin foam, under pressure with one stroke of a 2-kg roller applied thereto, and then this was left as such for 24 hours to be a test sample.

The substrate side of the carrier tape of the test sample was fixed on a support plate (for example, Bakelite plate having a thickness of 2 mm) via a high-power double-coated pressure-sensitive adhesive tape (Nitto Denko's trade name “No. 500”) therebetween so that the test sample should neither leave nor peel from the support plate during the test; and the force necessary for peeling the resin foam from the carrier tape was measured in an atmosphere having a temperature of 23±2° C. and a humidity of 50±5 RH %, under a high-speed peeling condition (tension rate, 10 m/min), and under a low-speed peeling condition (tension rate, 0.3 m/min), and the pressure-sensitive adhesive force (N/20 mm) of the sample was thus determined.

In the test under the high-speed peeling condition, used was a high-speed peeling tester (by Tester Industries); and in the test under the low-speed peeling condition, used was a universal tensile compression tester (Minebea's “TCN-1kNB”).

### (Presence or Absence of Foam Breakage)

In the two tests under the high-speed peeling condition and the low-speed peeling condition, the peeling condition of each sample was observed visually, and the resin foam was checked for the presence or absence of surface breakage.

In the column of “foam breakage” in Table 1, “Absence” means the absence of surface breakage of the resin foam of the sample, and “Presence” means the presence of surface breakage of the resin foam of the sample.

TABLE 1

| | | | | | | Pressure-sensitive | |
|---|---|---|---|---|---|---|---|
| | | | | | | Adhesive Force | |
| | Surface Hot Melt | | | | | (N/20 mm) | |
| | Treatment Condition | | | Surface | | | high- |
| | roll | | | Coating | | low-speed | speed |
| | temperature | gap | L* | Ratio | Foam | peeling | peeling |
| | (° C.) | (mm) | (lightness) | (%) | Breakage | condition | condition |
| Example 1 | 150 | 1.0 | 30.95 | 49.2 | Absence | 0.32 | 0.11 |
| Example 2 | 150 | 0.9 | 29.90 | 62.1 | Absence | 0.35 | 0.14 |
| Example 3 | 160 | 1.0 | 29.13 | 64.6 | Absence | 0.42 | 0.14 |
| Example 4 | 160 | 0.9 | 27.17 | 75.4 | Absence | 0.41 | 0.14 |
| Example 5 | 160 | 0.8 | 27.76 | 83.7 | Absence | 0.49 | 0.16 |
| Example 6 | 170 | 1.0 | 28.05 | 88.9 | Absence | 0.46 | 0.17 |
| Comparative | — | — | 33.91 | 24.3 | Absence | 0.11 | 0.06 |
| Example 1 | | | | | | | |
| Comparative | 140 | 0.9 | 32.76 | 35.3 | Absence | 0.26 | 0.12 |
| Example 2 | | | | | | | |

The same samples as those for the adhesive force measurement were produced, and left in an atmosphere at a temperature of 23±2° C. and a humidity of 50±RH % for 24 hours, and then checked for the presence or absence of “leaving or peeling” between the resin foam and the carrier tape therein. As a result, all the samples showed neither “leaving” nor “peeling”.

As is obvious from Examples and Comparative Examples, the samples having a larger surface coating ratio tended to have a larger peeling force from the carrier tape. In addition, when the surface hot melt treatment was attained under the condition of accelerating the heat treatment by elevating the temperature or by narrowing the gap, then the surface coating ratio increased and the peeling force also increased. In Examples, the pressure-sensitive adhesive force under the low-speed peeling condition is more than 0.3 N/20 mm. Therefore, in these, in case where the foamed member prepared by laminating a pressure-sensitive adhesive layer on the resin foam is fixed to a carrier tape, and then a supporting board is fitted onto the pressure-sensitive adhesive layer and this is worked, and when the supporting board attached to the pressure-sensitive adhesive layer is peeled from the thus-worked foamed member in order that the worked foamed member is installed in a device, there occurs no problem of peeling of the foamed member from the carrier tape to retard the installation operation. Further, in Examples, the surface coating ratio is 40% or more, and therefore the samples satisfy both the foam breakage resistance in peeling from the carrier tape and the adhesiveness of the carrier tape.

In Examples, the resin foam was produced in a simple step of surface hot melt treatment, and before and after the surface hot melt treatment, there was no change in the physical properties of the resin foam. In peeling, there occurred no foam breakage, and the integrality between the foam layer and the surface layer in the resin foam was good.

### (Evaluation 2)

The FT-IR chart of the hot melt-treated surface of the test sample in Example 1, and the FT-IR chart of the cross section of the test sample halved for the thickness thereof are shown in FIG. 1. The data of the hot melt-treated surface are those provided by the surface layer of the test sample; and the data of the cross section of the test sample halved for the thickness thereof are those provided by the foam layer of the test sample. The “cross section of the test sample halved for the thickness thereof” is the cross section cut in the direction perpendicular to the thickness direction of the test sample.

For the measurement, used was Perkin Elmer's “FT-IR spectrometer SPECTRUM 2000” with a Specac's silver gate)(Ge45°) for single reflection ATR measurement installed therein. In this, the sample was so set that it could cover the entire surface of the Ge crystal, and the sample and the Ge crystal were kept in airtight contact with each other by putting a silicone rubber having a thickness of 1 mm between the sample and the check. The resolution power was 4 cm⁻¹; and the cumulated number was 16 times.

In the charts of FT-IR analysis in FIG. 1, the main absorptions were the same. Accordingly, it is confirmed that the main polymer component in the foam layer part and the surface layer part is the same, and the composition of the surface layer is the same as that of the foam layer.

Like in the above, the hot melt-treated surface and the halved cross section of the samples in the other Examples were also analyzed through FT-IR analysis, and as a result, the same FT-IR charts as in FIG. 1 were obtained. Accordingly, also in the other Examples, it is confirmed that the main polymer component in the foam layer part and the surface layer part is the same, and the composition of the surface layer is the same as that of the foam layer.

While the invention has been described in detail with reference to specific embodiments thereof, it will be apparent to one skilled in the art that various changes and modifications can be made therein without departing from the spirit and scope thereof.

Incidentally, the present application is based on Japanese Patent Application No. 2009-160242 filed on Jul. 6, 2009, and the contents are incorporated herein by reference.

Also, all the references cited herein are incorporated as a whole.

According to the resin foam of the present invention, since it has the constitution as above, even though it has a high expansion ratio, foam breakage can be suppressed or prevented in peeling it from a carrier tape, and it is excellent in characteristics with a carrier tape such as workability and conveyability while held by a carrier tape.

What is claimed is:

1. A resin foam comprising a foam layer and a surface layer,
wherein the foam layer has a same composition as the surface layer, and the surface layer has a surface coating ratio defined by the following formula (1) of 40% or more:
$$Surface Coating Ratio ( \% ) = \frac{[ ( Area of surface ) - ( Area of pores existing in surface ) ]}{( Area of surface )} \times 100 \qquad ( 1 )$$

2. The resin foam according to claim 1, wherein the foam layer has an apparent density of 0.20 g/cm³ or less.

3. The resin foam according to claim 1, wherein a resin constituting the resin foam is a thermoplastic resin.

4. The resin foam according to claim 3, wherein the thermoplastic resin is a polyolefin resin.

5. The resin foam according to claim 1, wherein the surface layer is formed through a hot melt treatment.

6. The resin foam according to claim 5, wherein a temperature for the hot melt treatment is not lower than a temperature defined by [(a softening point or a melting point of the resin constituting the resin foam)−15° C.].

7. The resin foam according to claim 3, being produced through a process of impregnating a resin composition including the resin with a high-pressure gas, followed by reducing the pressure.

8. The resin foam according to claim 7, wherein the gas is an inert gas.

9. The resin foam according to claim 8, wherein the inert gas is carbon dioxide.

10. The resin foam according to claim 7, wherein the high-pressure gas is in a supercritical state.

11. The resin foam according to claim 1, having a closed cell structure or a semi-interconnected semi-closed cell structure.

12. The resin foam according to claim 1, wherein a surface of the surface layer has a lightness L* of 33.0 or less.

13. A foamed member comprising the resin foam according to claim 1.

14. The foamed member according to claim 13, having the surface layer on one side of the foam layer and having a pressure-sensitive adhesive layer on the other side thereof.

15. The foamed member according to claim 14, wherein the pressure-sensitive adhesive layer is an acrylic pressure-sensitive adhesive layer.

16. The foamed member according to claim 13, being used in electric/electronic devices.

17. A foamed member laminate having a constitution where the resin foam according to claim 1 is supported on a carrier tape having a substrate and a pressure-sensitive adhesive layer on at least one surface of the substrate, wherein the resin foam is stuck to the carrier tape in a form of contacting the surface layer with the pressure-sensitive adhesive layer of the carrier tape.

18. An, electric/electronic device comprising the foamed member for electric/electronic devices according to claim 16.
